(19) United States
(12) Patent Application Publication
(10) Pub. No.: US 2006/0144906 A1
(43) Pub. Date: Jul. 6, 2006

(54) Ultrasonic welder with high-Q tool

(76) Inventors: James F. Sheehan, Warren, CT (US); Robert S. Griswold, Ansonia, CT (US)

Correspondence Address: HARNESS, DICKEY & PIERCE, P.L.C., P.O. BOX 828, BLOOMFIELD HILLS, MI, 48303, US

(21) Appl. No.: 11/325,684

(22) Filed: Jan. 4, 2006

Related U.S. Application Data
(60) Provisional application No. 60/641,539, filed on Jan. 5, 2005.

(51) Int. Cl. B23K 20/10

(52) U.S. Cl. 228/110.1

(57) ABSTRACT

An ultrasonic welding apparatus and method uses a high-Q tool to increase the Q of a weld stack. In an aspect, the high Q-tool is a booster. In an aspect, the high-Q booster is a full wave booster. In an aspect, the high-Q booster is a radially resonant booster. In an aspect, the high-Q tool is a radially resonant tool. In an aspect, the Q of the weld stack is increased by the use of the high-Q tool while retaining a particular gain level.

### CROSS-REFERENCE TO RELATED APPLICATIONS

This application claims the benefit of U.S. Provisional Application No. 60/641,539 filed on Jan. 5, 2005.

### GOVERNMENT RIGHTS

The U.S. Government has a paid-up license in this invention and the right in limited circumstances to license other on reasonable terms as provided for by the terms of NIST ATP #70NANB3H3015 awarded by the Department of Commerce.

### FIELD OF THE INVENTION

The present invention relates to an ultrasonic welding apparatus and method, and more particularly to an ultrasonic apparatus and method for welding by vibrations applied in a direction parallel to the work piece surface, also known as shear wave vibrations.

### BACKGROUND OF THE INVENTION

A model of a typical ultrasonic metal welding apparatus 100 is shown in FIG. 1. Typical components of ultrasonic metal welding apparatus 100 include an ultrasonic transducer 102, a booster 104, and an ultrasonic horn 106. Booster 104 is coupled to transducer 102 and horn 106 by polar mounts (not shown) which are, at outer circumferential edges, mounted to opposed ends of a cylinder 105. Electrical energy from a power supply 101 at a frequency of 20-60 kHz is converted to mechanical energy by the ultrasonic transducer 102. The ultrasonic transducer 102, booster 104, and horn 106 are all mechanically tuned to match the power supply electrical input frequency. The mechanical energy converted in the ultrasonic transducer 102 is transmitted to a weld load 108 (such as two pieces of metal 112, 114) through the booster 104 and the horn 106 (which are typically ½ wave axial resonant tools). The booster 104 and the horn 106 perform the functions of transmitting the mechanical energy as well as transforming mechanical vibrations from the ultrasonic transducer 102 by a gain factor. Booster gains typically run from 1:0.5 to 1:2. Horn gains typically run from 1:1 to 1:3. Booster and horn gains take an output amplitude (from the ultrasonic transducer 102) of 20 μm peak to peak and factor this amplitude up or down.

The mechanical vibration that results on a horn tip 110 is the motion that performs the task of welding metal together. Essentially an axial displacement is produced by the ultrasonic transducer 102, modified in gain by the booster 104, and again modified in gain by the horn 106. The metal pieces 112, 114 to be welded together are placed adjacent to the weld tip (horn tip 110). As a perpendicular force (shown by arrows 116) is applied to weld stack 118 (ultrasonic transducer 102, booster 104 and horn 106), the horn tip 110 will come in contact with top metal piece 112 to be welded. The axial vibrations of the ultrasonic horn 106 now become shear vibrations to the top metal piece 112. As the weld clamp force 116 is increased, the shear vibrations will increasingly be transmitted to the top metal piece 112, causing it to move back and forth. A weld anvil 120 grounds the bottom metal piece 114. The back and forth motion of the top metal piece 112 relative to the bottom metal piece 114 will scrub the oxides and contaminates away from the surfaces of metal pieces 112,114 that are in contact with each other. After an amount of time under this shear motion and clamp force, the metal material in the weld area between the two metal pieces 112, 114 will become entangled and eventually bond.

The amount of amplitude needed at the horn tip 110 is typically a function of the material being welded and time required for bonding. Use of greater weld amplitude at the horn tip 110 will cause more electrical power to be converted in the ultrasonic transducer 102 and lead to bonding of weld material in shorter times. Use of lower amplitude at the weld tip 110 will cause less electrical power to be converted in the ultrasonic transducer 102 and lead to bonding of weld material in longer times. A designation of weld amplitude at the horn tip 110 will dictate the design of the gain factors of the horn 106 and booster 104 combination since the output of the ultrasonic transducer 102 is typically fixed (for example, 20 μm peak to peak)

The material being welded will also dictate how much amplitude is required at the horn tip 110. Typical horn amplitudes used in metal welding range from 40 μm to 80 μm (peak to peak). In the case of aluminum, amplitudes above 50-60 μm (peak to peak) become problematic. At higher horn amplitudes, there is a tendency to heat the aluminum and cause it to soften. If the interface area of the top metal piece 112 softens enough, the horn tip 110 will penetrate into the top metal piece 112 and weaken the parent material, which compromises the weld quality. Typically in aluminum welding, it is generally desirable that the horn amplitude remain below 55 μm (peak to peak) for this reason.

It is now important to discuss the ultrasonic or weld stack 118 and weld load 108 in terms of mechanical impedance. The weld stack 118 and weld load 108 can be expressed in terms of impedance as:
Z(stack)=−jk(stack)/ω+jωm(stack)+c(stack)
Z(load)=−jk(load)/ω+jωm(load)+c(load)
Where k(stack) and m(stack) are the net stiffness and mass of the ultrasonic transducer 102, booster 104, and horn 106, k(load) and m(load) are the net stiffness and mass of the weld load 108, and c(stack) and c(load) are the damping terms of the weld stack 118 and weld load 108.

In most current ultrasonic welding apparatuses, the power supply 101 operates the weld stack 118 at its resonant point or frequency. This resonant frequency ωₙ is essentially the frequency at which the reactive portions of the impedance of the weld stack 118 cancel each other, which is the frequency where the stiffness term cancels with the mass term. In reality this becomes more complicated since some electrical components of the power supply 101 and the capacitance of the ultrasonic transducer 102 are involved with the determination of this resonance point. Practically, the power supply 101 will operate the weld stack 118 at a resonant frequency ωₙ at which the reactive portions cancel. The power supply 101 typically has the capability to track this resonance frequency ωₙ in case the impedance characteristics of the weld stack 118 change (e.g., when the weld stack 118 heats the stiffness term may change).

During the weld cycle, the weld stack 118, operating at its resonant frequency, comes into contact with weld load 108. Since weld load 108 has its own impedance Z(load), the impedance of weld load 108 will combine with the impedance of weld stack 118. For an ideal load, the load impedance is just Z(load)=c. In this case, the resonant frequency of weld stack 118 doesn't change (or changes very little). In the case of aluminum material, however, the impedance characteristics of the load, Z(load), involves large reactive components, −jk(load)/ω and jωm(load). In addition, the value of these reactive components are variable throughout the weld cycle. In this case, the power supply 101 will need to adjust the resonance frequency ωₙ to track this ever-changing resonance point. If Z(load) contains large enough reactive components, the frequency changes and rate of frequency changes that the power supply needs to track will become quite large, possibly exceeding the capability of the power supply to track the changes.

The effect of the reactive components of the weld load 108 can be reduced by changing the magnitude of the reactive components of the impedance of the weld stack 118. By making the reactive components of the impedance of the weld stack 118 larger, the effect of variations in the impedance of the weld load 108 can be minimized. A diagram of the concept is shown below. FIG. 2 shows the relative magnitude of Z(stack) 200 to Z(load) 202 reactive impedances in a typical weld stack 118. FIG. 3 shows the relative magnitude of Z(stack) 300 to Z(load) 302 reactive impedances in a weld stack 118 that has been modified to increase the reactive portion of the impedances. In each case the impedance of weld load 108 stays the same.

Adding reactive components to the weld stack 118 needs to be done with both the mass and stiffness terms, since the resonant frequency ωₙ at which weld stack 118 operates needs to stay roughly the same. If the dissipation of the weld stack 118 remains the same (c(stack)) and the reactive components increase, the “Q” (commonly referred to as the “Quality Factor”) of the weld stack 118 is essentially increased since Q is:

$$\begin{matrix}Q = stack energy stored / stack energy dissipated \\ = ω m / c \\ = 1 / ( 1 / k ) ω c\end{matrix}$$

A straightforward manner to increase the Q of weld stack 118 is to increase the gain factors of the booster 104 and the horn 106. While this technique can substantially increase the Q of weld stack 118, it will also increase the output amplitude of the horn 106. In the case of welding aluminum, where the maximum amplitude at which aluminum can be welded is limited, additional amplitude becomes a serious problem.

Shear welding aluminum requires that weld amplitudes no higher than 55 μm be used. Any weld amplitude higher than this causes surface melting in the area where horn tip 110 contacts top metal piece 112. A typical method of obtaining this amplitude was to use a standard output 20 kHz transducer (22 μm, peak to peak amplitude) as ultrasonic transducer 102, a 0.6 reverse gain booster as booster 104 and a 4:1 high gain horn as horn 106. The use of the reverse gain booster as booster 104 in weld stack 118 contributes to a relatively small Q. The welding characteristics of a low Q weld stack in welding aluminum resulted in large phase shifts and frequency changes through the weld cycle. These variations were also experienced from weld to weld, with high variations in the power profiles. The weld to weld variations led to high standard deviations in pull strength test results.

### SUMMARY OF THE INVENTION

An ultrasonic welding apparatus in accordance with the present invention uses a high-Q tool to increase the Q of a weld stack. In an aspect, the high Q-tool is a booster. In an aspect, the high-Q booster is a full wave booster. In an aspect, the high-Q booster is a radially resonant booster. In an aspect, the high-Q tool is a radially resonant tool. In an aspect, the Q of the weld stack is increased by the use of the high-Q tool while retaining a particular gain level.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a prior art ultrasonic welding apparatus;

FIG. 2 is a schematic view showing relative magnitudes of stack impedance to weld load in the ultrasonic welding apparatus of FIG. 1;

FIG. 3 is a schematic view showing relative magnitude of stack impedance to weld load in an ultrasonic welding apparatus having a stack in which the reactive portions of impedances have been increased;

FIG. 4 is a schematic view of an ultrasonic welding apparatus having a high-Q full wave booster in accordance with an aspect of the invention;

FIG. 5 is a side view of the high-Q full wave booster of FIG. 4;

FIG. 6 is a schematic view of an ultrasonic welding apparatus having a high-Q radial booster in accordance with an aspect of the invention;

FIG. 7 is an end view of the high-Q radial booster of FIG. 6;

FIG. 8 is a section view of the high-Q radial booster of FIG. 6 taken along the line 8-8 of FIG. 7;

FIG. 9 is a schematic view of an ultrasonic welding apparatus having a high-Q tool in accordance with an aspect of the invention.

### DETAILED DESCRIPTION OF THE PREFERRED EMBODIMENTS

The following description of the preferred embodiment(s) is merely exemplary in nature and is in no way intended to limit the invention, its application, or uses.

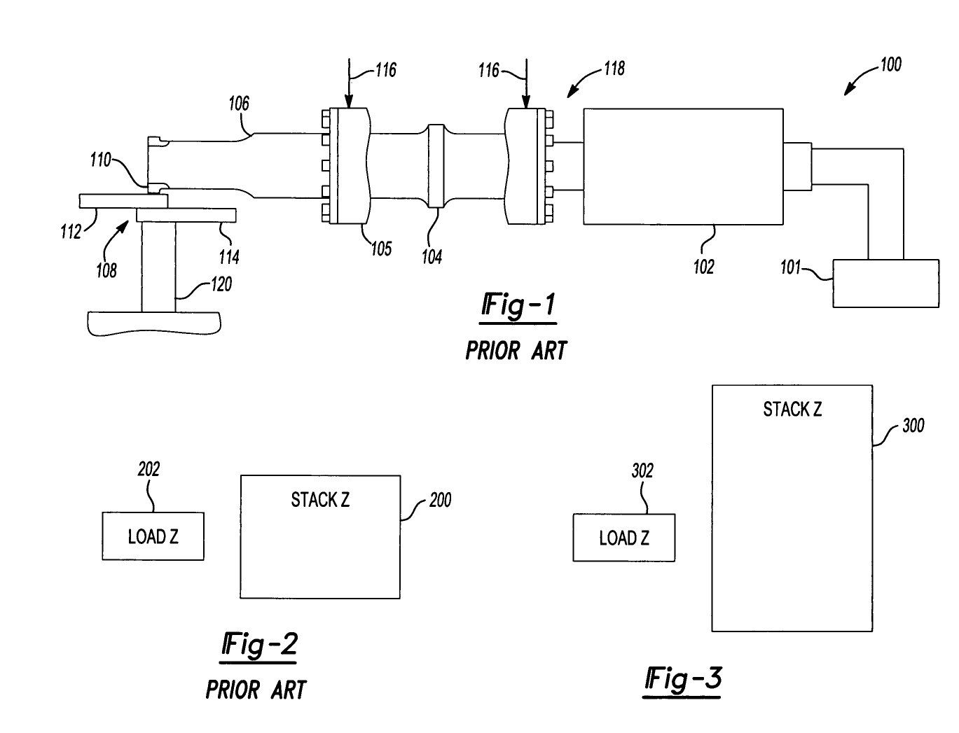

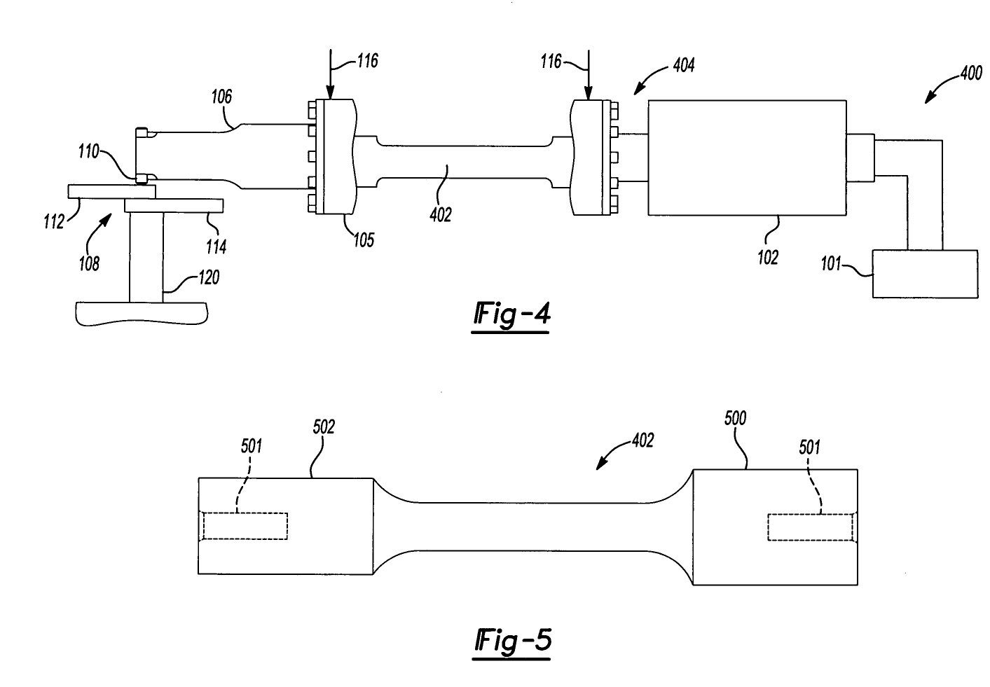

Referring to FIG. 4, an ultrasonic metal welding apparatus 400 in accordance with the invention is described. Elements in common with ultrasonic welding apparatus 100 of FIG. 1 will be referred to by the same reference numbers, and only the differences will be discussed.

In ultrasonic metal welding apparatus 400, a high-Q tool is used in weld stack 404 in lieu of the half-wave booster 104 used in the prior art ultrasonic metal welding apparatus 100 shown in FIG. 1. In the aspect of FIG. 4, the high-Q tool is illustratively a full wave booster and referred to as high-Q full wave booster 402. High-Q full wave booster 402 is a “high-Q” booster, meaning that it has a Q of at least three times the Q of ½ wave booster 104 but with an equivalent gain. Use of high-Q full wave booster 402 achieves a high stored energy content (high Q) in weld stack 404 compared with weld stack 118 shown in FIG. 1 in which ½ wave booster 104 is used.

FIG. 5 shows in more detail full wave booster 402, which illustratively comprises two back-to-back ½ wave boosters. In the embodiment shown in FIG. 5, full waver booster 402 integrally includes the two back-to-back ½ wave boosters, having an input ½ wave side 500 and an output ½ wave side 502. Input ½ wave side 500 is mounted to ultrasonic transducer 102 and output ½ wave side 502 is mounted to horn 106. In this regard, input ½ wave side 500 includes a longitudinally extending slot 501 which receives a stud (not shown) of ultrasonic transducer 102 to mount input ½ wave side 500 to ultrasonic transducer 102 and ½ wave output side 502 includes a similar slot 501 which receives a stud (not shown) of horn 106 to mount ½ wave output side 502 to horn 106. Slots 501 may illustratively be tapped and the corresponding studs of ultrasonic transducer 102 and horn 106 threaded. It should be understood, however, that input ½ wave side 500 and output ½ wave side 502 need not be integral with each other. For example, two ½ wave boosters with the appropriate gains could be mounted together back-to-back. For use with aluminum, full wave booster 402 is illustratively made of titanium and configured by appropriate dimensioning and mass to provide a net gain of 1:0.6, with the input ½ wave side 500 providing a gain increase of 1:2.5 and the output ½ wave side providing a gain reduction of 4:1. For example, when ultrasonic transducer 102 is a Branson 101-135-124 (HP converter) available from Branson Ultrasonics of Danbury, Conn., producing mechanical energy at a frequency of 20 KHz and ultrasonic horn 106 is a Branson L1A90A53 (metal welding horn), full wave high-Q booster may illustratively have a length of 11.03 inches, an input diameter of 1.6 inches, an output diameter of 2.00 inches, a shaft diameter of 0.75 inches, and a mass of 1.3 kg. The stored energy content in full wave booster 402 is equivalent to the sum of a 1:4 and 1:2.5 gain ½ wave boosters.

Finite element analyses of a standard 1:1 gain ½ wave titanium booster and booster 402 having a gain of 1:0.6 were performed, both using amplitude inputs of 20 μm (peak to peak). The strain energy of each was extracted on one extension cycle. The results showed that the standard booster had strain energy of 0.56 Joules per cycle and booster 402 had strain energy of 2.7 Joules per cycle. The full wave booster 402 thus had 4.8 times the strain energy of a standard 1:1 gain ½ wave titanium booster. The ratio would be even larger if booster 402 was compared with a standard ½ wave titanium booster having a gain of 1:0.6.

While the specific example of booster 402 described with reference to FIG. 5 has a gain of 1:0.6, it should be understood that booster 402 can be configured with other gains, such as 1:1, 1:1.2, 1:2, and so forth.

Ultrasonic metal welding apparatus 400 in which full wave booster 402 is used has a number of advantages over ultrasonic welding apparatus 100 in which ½ wave booster 104 is used. For a particular desired gain level, the stored energy in weld stack 404 is increased. This reduces frequency changes and the rate of frequency changes during metal welding. Reducing frequency changes and the rate of frequency changes make it easier for the power supply 101 to track the resonant frequency of weld stack 404, thus making it easier to set the resonance frequency ωₙ at which weld stack 404 operates.

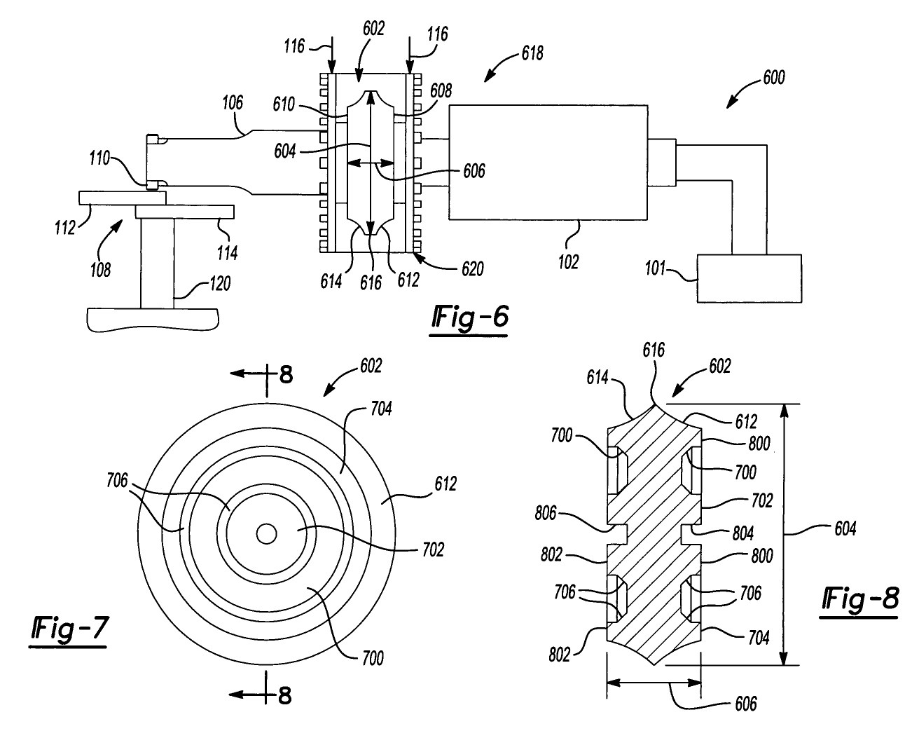

Referring to FIG. 6, an ultrasonic welding apparatus 600 having a high-Q tool in accordance with an aspect of the invention is shown. In the aspect of FIG. 6, high-tool is a high-Q radially resonant booster and will be referred to as high-Q radially resonant booster 602. Elements in common with ultrasonic welding apparatus 100 of FIG. 1 and ultrasonic welding apparatus 400 of FIG. 4 will be referred to by the same reference numbers, and only the differences discussed.

In ultrasonic welding apparatus 600, a high-Q radially resonant booster 602 is used in weld stack 618 to couple ultrasonic transducer 102 to horn 106. High-Q radially resonant booster 602 is dimensioned to be radially resonant, illustratively at the frequency at which ultrasonic transducer 102 produces mechanical energy. In particular, high-Q radially resonant booster 602 is generally cylindrical having a diameter 604 and an axial length 606 where diameter 604 is greater than or equal to the axial length 606 making high-Q radially resonant booster 602 radially resonant. While high-Q radially resonant booster 602 has axial input and output motion, the bulk of motion of high-Q radial radially resonant booster 602 is in the radial direction. As such, all (or at least most) of the gain of high-Q radially resonant booster 602 is in the radial direction. In this regard, the axial gain of high-Q radially resonant booster 602 may illustratively be 1:1. FIGS. 7 and 8 show in more detail high-Q radially resonant booster 602. High-Q radially resonant booster 602 may illustratively be a solid ring having opposed sides 608, 610 with ring shaped recesses 700 (FIGS. 7 and 8) in each of opposed sides 608, 610 between inner portions 702 and outer portions 704 thereof. Opposed sides 608, 610 at an outer edge of outer portion 704 curve concavely at 612, 614, respectively, out to flattened peak 616. Opposed sides 608, 610 of high-Q radially resonant booster 602 are input and output sides, respectively of high-Q radially resonant booster 602. Inner and outer sides of recesses 700 are radiused at 706 as they extend out to outer surfaces 800, 802 (FIG. 8) of opposed sides 608, 610, respectively. Inner portion 702 of input side 608 of high-Q radially resonant booster 602 includes a slot 804 that receives a stud (not shown) of ultrasonic transducer 102 to couple input side 608 of high-Q radially resonant booster 602 to ultrasonic transducer 102. Inner portion 702 of output side 610 of high-Q radially resonant booster 602 includes a slot 806 that receives a stud (not shown) of horn 106 to couple output side 610 of high-Q radially resonant booster 602 to horn 106. Polar shell 620 is mounted to ultrasonic transducer 102 and horn 106. Slots 804, 806 may illustratively be tapped and the corresponding studs of polar shell 620 threaded.

Illustratively, when ultrasonic transducer 102 is a Branson 101-135-124 (HP converter) that produces mechanical energy at a frequency of 20 KHz and ultrasonic horn 106 is a Branson L1A90A53 (metal welding horn), high-Q radially resonant booster 602 may illustratively have a diameter 604 of 6.70 inches and an axial length 606 of 2.50 inches so that it is radially resonant at 20 KHz. High-Q radially resonant booster 602 may then illustratively be made of titanium and have an illustrative mass of 4.27 kg. High-Q radially resonant booster 602 may then illustratively have a gain of 1:1 and stored or strain energy of 6.28 Joules per cycle. In this illustrative embodiment, the stored energy of 6.28 Joules of high-Q radially resonant booster is significantly greater (more than eleven times) the 0.56 Joules per cycle of stored energy of prior art booster 104 with the same 1:1 gain. It also has almost three times the 2.7 Joules per cycle of stored energy of the above described embodiment of full wave high-Q booster 402. High-Q radially resonant booster 602 also has a much shorter axial length than prior art booster 104 or full wave high-Q booster 402. High-Q radially resonant booster 602, by providing significantly greater stored energy than the prior art booster 104, provides many of the same advantages over the prior art booster 104 that full wave high-Q booster 402 provides, as discussed above.

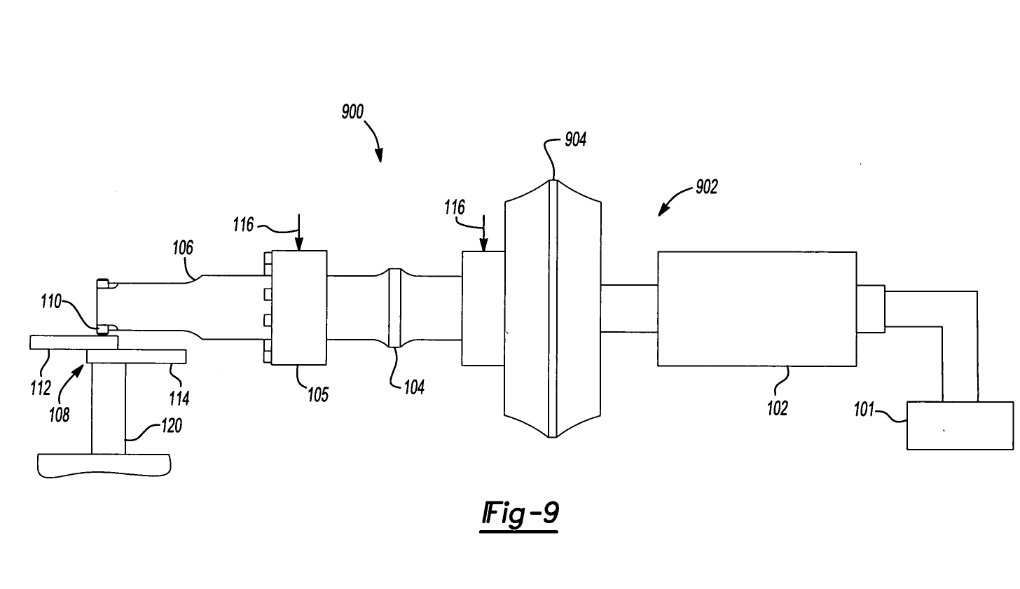

Referring to FIG. 9, an ultrasonic welding apparatus 900 having a high-Q tool disposed in weld stack 902 in accordance with an aspect of the invention is shown. Elements in common with ultrasonic welding apparatus 100 of FIG. 1 will be referred to by the same reference numbers, and only the differences discussed.

Ultrasonics welding apparatus 900 is a modification of ultrasonic welding apparatus of FIG. 1 by the addition of a high-Q tool 904 in weld stack 902. In the aspect of FIG. 9, the high-Q tool is illustratively a high-Q radially resonant tool and referred to as high-Q radially resonant tool 904. High-Q radially resonant tool 904 in the aspect shown in FIG. 9 is disposed between ultrasonic transducer 102 and half-wave booster 104. High-Q radially resonant tool 904 is coupled on an input side to an output side of ultrasonic transducer 102 and on an output side to half-wave booster 104 by a polar mount (not shown). High-Q radially resonant tool may illustratively have the same configuration as high-Q radially resonant booster 602. High-Q radially resonant tool 904 increases the stored energy of weld stack 902 and provides many of the same advantages that full wave high-Q booster 402 and high-Q radially resonant booster 602 provide. It should be understood that high-Q radially resonant tool 904 could be disposed in other portions of weld stack 902.

While the invention has been described with reference to welding aluminum, it should be understood that it is useful in ultrasonically welding materials where additional stored ultrasonic energy in the weld stack is needed, such as in high power applications for sono-chemical, thin plastics, and metals.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An ultrasonic welding apparatus comprising a power supply coupled to a weld stack, the weld stack including an ultrasonic transducer, a horn and a high-Q tool.

2. The apparatus of claim 1 wherein the high-Q tool is a high-Q booster disposed between the ultrasonic transducer and the horn.

3. The apparatus of claim 2 wherein the high-Q booster is a full wave booster.

4. The apparatus of claim 3 wherein the high-Q booster includes a ½ wave input side and a ½ wave output side, the ½ wave input side having a gain increase and the ½ wave output side having a gain decrease.

5. The apparatus of claim 4 wherein the ½ wave input side of the high-Q booster has a gain increase of 1:2.5 and the ½ wave output side of the high-Q booster has a gain decrease of 4:1.

6. The apparatus of claim 3 wherein material welded with the ultrasonic welding apparatus is aluminum.

7. The apparatus of claim 6 wherein a weld amplitude at a tip of the horn is a maximum of 55 μm, the high-Q booster providing the weld stack at least two Joules per cycle of stored energy without increasing the weld amplitude above the maximum of 55 μm.

8. The apparatus of claim 2 wherein material welded with the ultrasonic welding apparatus is aluminum and the welding apparatus has a weld amplitude at a tip of the horn, the high-Q booster providing the weld stack at least two Joules per cycle of stored energy without increasing the weld amplitude above a maximum weld amplitude for material being welded with the ultrasonic welding apparatus.

9. The apparatus of claim 2 wherein the high-Q booster is a high-Q radially resonant booster.

10. The apparatus of claim 9 wherein the high-Q radially resonant booster is generally cylindrical having a diameter and an axial length, the diameter of the high-Q radially resonant booster greater than or equal to the axial length of the high-Q radially resonant booster.

11. The apparatus of claim 10 wherein the high-Q radially resonant booster is a solid ring.

12. The apparatus of claim 11 wherein the solid ring includes an input side and an output side, each of the input and output sides having a ring shaped recess therein disposed between inner and outer portions thereof.

13. The apparatus of claim 9 wherein material welded with the ultrasonic welding apparatus is aluminum and the welding apparatus has a weld amplitude at a tip of the horn, the high-Q booster providing the weld stack at least two Joules per cycle of stored energy without increasing the weld amplitude above a maximum weld amplitude for material being welded with the ultrasonic welding apparatus.

14. The apparatus of claim 1 wherein the weld stack includes a half-wave booster disposed between the ultrasonic transducer and the horn.

15. The apparatus of claim 14 wherein the high-Q tool is a radially resonant high-Q tool disposed between the ultrasonic transducer and the half-wave booster.

16. The apparatus of claim 15 wherein material welded with the ultrasonic welding apparatus is aluminum and the welding apparatus has a weld amplitude at a tip of the horn, the high-Q tool providing the weld stack at least two Joules per cycle of stored energy without increasing the weld amplitude above a maximum weld amplitude for material being welded with the ultrasonic welding apparatus.

17. A method of ultrasonically welding material that requires high stored ultrasonic energy in a weld stack of an ultrasonic welding apparatus, the method comprising welding the material with an ultrasonic welding apparatus that has a weld stack having a high-Q tool.

18. The method of claim 17 wherein welding the material with the ultrasonic welding apparatus includes welding the material with an ultrasonic welding apparatus in which the high-Q tool is a high-Q booster.

19. The method of claim 18 wherein welding the material with the ultrasonic welding apparatus includes welding the material with an ultrasonic welding apparatus in which the high-Q booster is a high-Q full wave booster.

20. The method of claim 18 wherein welding the material with the ultrasonic welding apparatus includes welding the material with an ultrasonic welding apparatus in which the high-Q booster is a high-Q radially resonant booster.

21. The method of claim 17 wherein the material to be welded is aluminum and welding the aluminum with the ultrasonic welding apparatus includes producing with the weld stack a weld amplitude that does not exceed 55 μm.

22. The method of claim 17 wherein welding the material with the ultrasonic apparatus includes welding the material with an ultrasonic apparatus in which the weld stack includes a half-wave booster disposed between an ultrasonic transducer and a horn and the high-Q tool is a radially resonant high-Q tool disposed between the ultrasonic transducer and the half-wave booster.

23. In an ultrasonic welding apparatus having a weld stack, the weld stack having an ultrasonic transducer, a horn, and a booster disposed between the transducer and the horn, a method of increasing stored ultrasonic energy of the weld stack without increasing a weld amplitude at a tip of the horn above a maximum for material to be welded with the ultrasonic welding apparatus, the method comprising using as the booster a high-Q booster.

24. The method of claim 23 wherein using the high-Q booster as the booster includes using a high-Q full wave booster as the booster.

25. The method of claim 24 wherein the material to be welded is aluminum and the maximum weld amplitude is 55 μm.

26. The method of claim 23 wherein using the high-Q booster as the booster includes using a high-Q radially resonant booster as the booster.

27. The method of claim 26 wherein the material to be welded is aluminum and the maximum weld amplitude is 55 μm.

28. The method of claim 23 wherein the material to be welded is aluminum and the maximum weld amplitude is 55 μm.

29. In an ultrasonic welding apparatus having a weld stack, the weld stack having an ultrasonic transducer, a horn and a booster disposed between the ultrasonic transducer and the horn, a method of increasing stored ultrasonic energy of the weld stack comprising disposing a high-Q tool in the weld stack.

30. The method of claim 29 wherein disposing a high-Q tool in the weld stack includes disposing a high-Q radially resonant tool between the ultrasonic transducer and the booster.

31. The method of claim 30 wherein the material to be welded is aluminum and the maximum weld amplitude is 55 μm.
